(19) United States
(12) Patent Application Publication
(10) Pub. No.: US 2004/0208726 A1
(43) Pub. Date: Oct. 21, 2004

(54) Bolt and process for producing a protective layer on a bolt

(76) Inventors: Christian Bohme, Mulheim an der Ruhr (DE); Thomas Link, Lichtenfels (DE); Albert Schrey, Kerken (DE)

Correspondence Address: SIEMENS CORPORATION, INTELLECTUAL PROPERTY DEPT., 170 WOOD AVENUE SOUTH, ISELIN, NJ, 08830, US

(21) Appl. No.: 10/794,570

(22) Filed: Mar. 5, 2004

(30) Foreign Application Priority Data
Mar. 6, 2003 (EP) 03005071.0

(51) Int. Cl. F16B 29/00

(52) U.S. Cl. 411/411; 411/914

(57) ABSTRACT

The invention relates to a process for producing a protective layer on a bolt, in which an aluminum-containing high-temperature lacquer is first of all applied to the bolt and then cured and stoved at a defined stoving temperature. The screw thread is additionally lubricated prior to installation of the bolt. This process reduces oxidation and ultimately reduces seizing of the screw connection.

### CROSS REFERENCE TO RELATED APPLICATION

This application claims priority of the European application No. 03005071.0 EP filed Mar. 6, 2003 under the European Patent Convention and which is incorporated by reference herein in its entirety.

### FIELD OF INVENTION

The invention relates to a bolt which is effectively protected against a high likelihood of seizing, and to a process for producing a protective layer on a bolt.

### BACKGROUND OF INVENTION

On account of the high temperatures of in some cases over 500° C. which prevail in the steam turbine sector, high-alloy bolts and nuts are used for mechanical connection between components used in steam turbines. These screw connections are often subject to a phenomenon known as seizing. Seizing is a type of wear caused by sticking which causes damage under relatively high loads. Strong seizing often leads to parts which engage in one another becoming jammed. Screwed-together parts are particularly known to be prone to seizing. If the two surfaces are pressed together under load, the surfaces which act on one another form strong bonds on account of the high local pressure and the heat which is generated by motion. If these connections come loose at the boundary surface, only minor damage occurs and the parts continue to run smoothly against one another. On the other hand, if local fractures occur in one of the materials, major damage results. This damage is also known as seizing.

To counteract seizing, the uncoated screw threads of the bolts have been treated with lubricant, for example with a lubricant composed of oil, thickener and solid lubricating substances. The use of this lubricant reduces the friction between the bolt and the screw thread. However, the oil constituents evaporate when the temperature rises, resulting in a lack of lubricating action, which means that seizing of the screw connection can still occur when it is unscrewed again.

Screw connections, flanged connections and plug-fit connections for high-temperature applications which are not lubricated are subject to increased levels of oxidation, which ultimately contributes to the screw connections, flanged connections and plug-fit connections seizing. Even the use of oils cannot satisfactorily fulfill the standard requirements imposed on the screw connections, since oils tend to dry out and burn, and therefore with oils there is a risk of drying out with subsequent wear to the surface of the screw thread when it is loosened again.

It is known from DE 40 05 502 A1 that a bolt which is coated with an aluminum-containing layer can be effectively protected from corrosion and rusting. The standard method used to produce a layer of this nature on a bolt which contains aluminum consists in introducing the bolts into a tank which contains a solution comprising a 50% strength diluting solvent as well as an aluminum-containing agent which consists of aluminum powder, silicone resin, alkyd resin and an aromatic solvent. Dipping the bolts into this solution produces a coating on the bolts. The bolts are then taken out of the tank and dried. However, this conventional method of producing an aluminum-containing coating on bolts has the following drawbacks: the solution comprising the aluminum-containing material runs on the surface of the bolt during the drying process, which leads to an uneven thickness of the coating on the bolt after drying.

During production of the solution, which contains an aluminum-containing material, in general 50 parts by volume of the diluting solvent are added, based on 100 parts by volume of this solution. This diluting solvent which is added to or contained in the solution evaporates into the air at the workplace and may harm the operator if he breathes in these vapors.

The bolts which have been dipped in the solution tend to stick together during the dipping and coating process. This means that some of the bolts are not sufficiently coated with the aluminum-containing agent and may become useless as a result of the bolts sticking together or bonding to one another.

DE 40 05 502 A1 describes a process for producing a protective layer on a bolt. A solvent, water and an aluminum-containing agent are mixed in a first tank in order to obtain an electrolytic solution. A large number of bolts are introduced into a second tank. The second tank is introduced into the first tank, so that the bolts are immersed in the electrolytic solution. As a result, an aluminum-containing layer is formed on each bolt as a result of electrolysis. The second tank is pivoted during the electrolysis. Then, the bolts are washed with water in order to remove the solvent residues which stick to the bolts.

### SUMMARY OF INVENTION

It is an object of the present invention to provide a screw connection which has a bolt and a mating screw thread and has a low tendency to seize, and to provide a process for producing a protective layer on a bolt or on a mating screw thread.

The object relating to the screw connection is achieved by a bolt having an aluminum-containing high-temperature lacquer on the screw thread.

The object relating to the screw connection is likewise achieved by a mating screw thread to which an aluminum-containing high-temperature lacquer is applied.

The use of an aluminum-containing high-temperature lacquer has the advantage that seizing of the bolts is greatly reduced.

In an advantageous configuration, the lower part of the thread is coated with the aluminum-containing high-temperature lacquer. As a result, that region of the bolt or screw thread which is subject to particularly high levels of load in use is provided with a protective layer.

The object relating to the process is achieved by an aluminum-containing high-temperature lacquer being applied to the bolt and then being cured and stoved. The advantage of this solution consists in particular in the fact that the process is very simple to manage. The process does not require any special safety features, and consequently it can also be used on site during maintenance, repair or commissioning.

In an advantageous configuration, the aluminum-containing high-temperature lacquer is applied at room temperature. This widens the possible applications for the process, since there is no need to provide special measures relating to the process temperature during coating of the bolt.

In a further advantageous configuration, the aluminum-containing high-temperature lacquer is applied in two thin layers. This gives the advantage that the likelihood of the bolt seizing is reduced by a second layer of the aluminum-containing high-temperature lacquer.

In a further advantageous configuration, the screw thread is lubricated with a lubricant after the aluminum-containing high-temperature lacquer has been stoved. This increases the lubrication of the thread and further reduces the risk of the bolt seizing.

The coated bolts can be used in turbo machines. In particular, the coated bolts can be used in steam turbines or in gas turbines.

### BRIEF DESCRIPTION OF THE DRAWING

The invention is explained in more detail below with reference to a drawing, in which:

FIG. 1 shows a longitudinal section through a coated bolt.

### DETAILED DESCRIPTION OF INVENTION

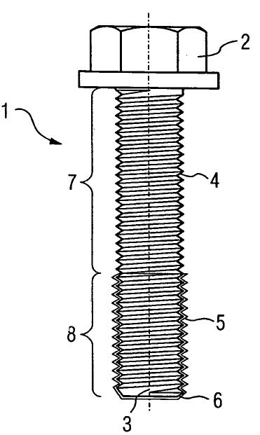

FIG. 1 shows a longitudinal section through a coated bolt 1. The bolt 1 has a head 2 and a screw thread 4 running along the longitudinal axis 3. In this exemplary embodiment, the thread 4 extends from the head 2 to the start of the bolt 6. The bolt 1 has an upper part 7 and a lower part 8 along its longitudinal axis 3, although the division between the upper part 7 and the lower part 8 of the bolt 1 may vary. Other embodiments of the bolt 1, such as for example a thread 4 which is only applied as a part of the longitudinal axis 3, can also be used. The bolts may, for example, consist of 12% strength chromium steel.

The bolt 1 can be used, inter alia, in steam turbine or gas turbine construction.

The bolt 1 is provided with an aluminum-containing high-temperature lacquer 5 over the entire thread 4. The aluminum-containing high-temperature lacquer does not have to be applied to the entire thread 4; for some applications, it is sufficient for the lower part 8 of the thread to be provided with the aluminum-containing high-temperature lacquer 5. Moreover, the bolt 1 may consist of high-alloy materials. The aluminum-containing high-temperature lacquer 5 can be applied to the mating screw thread. This still provides the desired advantage of a reduced likelihood of seizing.

The process is simple to implement. An aluminum-containing high-temperature lacquer is applied in two thin layers at room temperature. The aluminum-containing high-temperature lacquer may be a commercially available aluminum-containing high-temperature lacquer. The two thin layers are applied successively with a time delay. The two thin layers are then dried and cured. The drying and curing may take place in air. The aluminum-containing high-temperature lacquer can then be stoved. The stoving temperatures may be between 160° C.-750° C. Before the bolt 1 is used, the thread 4 is additionally lubricated. A commercially available lubricant is used for this purpose. The likelihood of the bolts seizing is greatly reduced by this process. This reduced likelihood of the bolts seizing makes it possible to save considerable costs.

1. A bolt for use in a turbo-machine, comprising:
an aluminum-containing high-temperature lacquer adapted to resist temperatures up to about 500° C. arranged on a screw thread.

2. The bolt as claimed in claim 1, further comprising a mating screw thread with the aluminum-containing high-temperature lacquer.

3. The bolt as claimed in claim 2, wherein the bolt has a lower threaded region, and the aluminum-containing high-temperature lacquer is applied only to the lower threaded region.

4. A process for coating a bolt, comprising:
coating the screw thread with an aluminum-containing high-temperature lacquer adapted to resist temperatures up to about 500° C.;
curing the aluminum-containing high-temperature lacquer; and
stoving the aluminum-containing high-temperature lacquer.

5. The process as claimed in claim 4, wherein the bolt is coated with an aluminum-containing high-temperature lacquer at room temperature.

6. The process as claimed in claim 4, wherein the aluminum-containing high-temperature lacquer is applied in two thin layers.

7. The process as claimed in claim 5, wherein the screw thread, after the aluminum-containing high-temperature lacquer has been stoved, is lubricated with a lubricant.

8. The bolt as claimed in claim 1, wherein the bolt is used in a steam turbine.

9. The bolt as claimed in claim 1, wherein the bolt is used in a gas turbine.

10. The bolt as claimed in claim 1, wherein the bolt is a housing bolt for a steam or gas turbine.

11. The method as claimed in claim 4, wherein the stoving temperature varies between 160° C.-750° C.
